(19) United States
(12) Patent Application Publication
(10) Pub. No.: US 2015/0328798 A1
(43) Pub. Date: Nov. 19, 2015

(54) LOG SPLITTER ASSEMBLY AND METHOD OF USE THEREOF

(71) Applicants: Carl Miller, Rochester, IL (US); Ronald Hickenbottom, Sullivan, IL (US); Michael R. Newman, Sullivan, IL (US)

(72) Inventors: Carl Miller, Rochester, IL (US); Ronald Hickenbottom, Sullivan, IL (US); Michael R. Newman, Sullivan, IL (US)

(21) Appl. No.: 14/667,360

(22) Filed: Mar. 24, 2015

Related U.S. Application Data
(60) Provisional application No. 62/000,360, filed on May 19, 2014.

(51) Int. Cl. B27L 7/06

(52) U.S. Cl. CPC B27L 7/06

(57) ABSTRACT

The present disclosure generally relates to devices and methods for splitting logs. In an embodiment, a log splitter assembly is configured such that the height of a the log splitter assembly may be adjusted. In an embodiment, a log splitter assembly is configured to require a user to employ two hands to activate the log splitter. In an embodiment, a log splitter assembly is configured to include a tow bar that may be retracted. In an embodiment, a log splitter assembly is configured such that the tension in a retraction may be adjusted. In an embodiment, a log splitter assembly includes a specialized housing bracket.

### RELATED APPLICATIONS

The present utility patent application claims priority from and the benefit of U.S. Provisional Patent Application No. 62/000,360, filed May 19, 2014, entitled VISIONAL LOG SPLITTER ASSEMBLY AND METHOD OF USE THEREOF, the contents of which are hereby incorporated by reference in their entirety.

### FIELD OF THE DISCLOSURE

The present disclosure generally relates to a log splitter designed to split logs, and more particularly to adjustable-height log splitters, log splitters featuring retractable tow bars, log splitters requiring two hands to operate, log splitters with adjustable retraction springs and/or log splitters with a specialized housing brackets.

### BACKGROUND

A log splitter is a conventional device for splitting sections of wood into smaller pieces. Generally, precut sections of logs or rounds must be separated into smaller pieces to be used as firewood. Similarly, logs may be divided into smaller sections to be used for commercial applications. Splitting logs manually, such as by using an axe or a manually operated saw, is both time and labor intensive. A log splitter allows an individual user to quickly and easily split a section of a log into several conveniently sized pieces.

In order to split a log, log splitters commonly employ a ram that drives a log section into a wedge. Frequently, the ram impacts the log section at high speed or exerts significant pressure upon the log section. Many conventional log splitters allow for one-handed operation, thereby creating a risk that the user's free hand may be harmed during operation of the log splitter. Accordingly, a need exists for a log splitter that improves user safety.

In operating a log splitter, a user often must manually lift a log section onto the device. For example, a user might be required to lift a log section from the ground or a cart and place it onto the log splitter. Once the log section has been split, the user must manually remove each split section from the device. Log splitters commonly come at a single fixed height that cannot be adjusted to accommodate the height of the user or the height of a cart or other device on which the log sections or split pieces are placed. As such, shorter users are required to raise log sections higher to place them on the log splitter, and taller users are required to bend over more in order to remove split sections from the log splitter. This increases the risk that a user will experience pain or injury from using the log splitter, as the device is not at an ergonomically desirable height. Accordingly, a need exists for an ergonomic log splitter that may be adjusted by a user.

Many log splitters are designed to be towed behind a vehicle so as to be easily transported from one location to another. Such devices may be attached to a vehicle via a tow bar. However, these tow bars are of fixed length and necessarily require that the log splitter be located a minimum distance away from the vehicle in order to safely tow the log splitter. Thus, if for example, split sections of wood are to be loaded into a truck towing a log splitter, the cut log sections must be carried between the log splitter and the truck bed. This increases both the time required to use the log splitter and the likelihood that a user will experience pain or injury from carrying the logs or wood pieces. Accordingly, a need exists for a towable log splitter that may be located farther from a vehicle while being towed and closer to a vehicle while in use.

Therefore, there is a need in the art for a log splitter assembly that overcomes the disadvantages of the prior art and provides the advantages as described in this disclosure.

### SUMMARY

The present disclosure generally relates to devices and methods for splitting logs. More particularly, embodiments described herein relate to a device for splitting logs that includes features for: adjusting the height of the device, improving safety by requiring activation using two hands, retracting a tow bar, adjusting the tension in a retraction spring and/or a specialized housing brackets.

In an example embodiment, a log splitter assembly is configured such that a user may adjust the height of a log support surface.

In an example embodiment, a log splitter assembly is adapted to be towed behind a vehicle and is configured such that the tow hitch and the tow bar may be retracted beneath the log support surface.

In an example embodiment, a log splitter assembly is configured to require a user to employ two hands to activate the log splitter by moving a safety lever forward before lifting an engagement lever.

In an example embodiment, a log splitter assembly is configured to allow a user to adjust the tension in a retraction spring in the log splitter.

In an example embodiment, a log splitter assembly is configured with a specialized housing bracket to remove debris from the bracket and prevent the bracket from rotating.

### BRIEF DESCRIPTION OF THE DRAWINGS

The following disclosure as a whole may be best understood by reference to the provided detailed description when read in conjunction with the accompanying drawings, drawing description, abstract, background, field of the disclosure and associated headings.

FIG. 1 is a perspective view of a log splitter assembly in accordance with one embodiment of the present disclosure.

FIG. 2 is a simplified cross-sectional view of a log splitter assembly configured for two-handed operation.

FIG. 3A is a detailed cross section of a log splitter assembly configured for two-handed operation.

FIG. 3B is a detailed cross section of the portion of the log splitter assembly shown in FIG. 3A surrounded by dashed line A.

FIG. 4 is a perspective view of the portion of a log splitter assembly shown in FIG. 3B.

FIG. 5 is a perspective view of the portion of a log splitter assembly shown in FIG. 3B.

FIG. 6A is a perspective view of a portion of an adjustable-height log splitter assembly.

FIG. 6B is a front view of the portion of an adjustable-height log splitter assembly shown in FIG. 6A.

FIG. 7 is a side view of a log splitter assembly with the log support surface in the highest of four positions.

FIG. 8 is a side view of the log splitter assembly of FIG. 7 with the log support surface in the lowest of four positions.

FIG. 9 is a rear view of the log splitter assembly of FIG. 7.

FIG. 10 is a rear view of the log splitter assembly of FIG. 8.

FIG. 11 is a side view of a portion of a log splitter assembly with a tow bar in an extended position.

FIG. 12 is a side view of the portion of a log splitter assembly shown in FIG. 11 in a retracted position.

FIG. 13 is a perspective view of the upper portion of a log splitter assembly with a tow bar in a retracted position.

FIG. 14 is a perspective view of the lower portion of a log splitter assembly with a tow bar in a retracted position.

FIG. 15 is a perspective view of a log splitter assembly with a tow bar in an extended position.

FIG. 16 is an exploded view of a log splitter assembly.

FIG. 17 is an exploded view of the portion of a log splitter assembly shown in broken lines in FIG. 16.

FIG. 18 is a perspective view of an adjustment bracket.

FIG. 19 is a top view of the adjustment bracket shown in FIG. 18.

FIG. 20 is a side view of the adjustment bracket shown in FIG. 18.

FIG. 21 is a perspective view of the adjustment bracket of FIG. 18 shown attached to a portion of a log splitter assembly.

FIG. 22 is top view of a housing bracket.

FIG. 23 is a side view of the housing bracket shown in FIG. 22.

FIG. 24 is a front view of the housing bracket shown in FIG. 22.

FIG. 25 is a perspective view of the housing bracket shown in FIG. 22.

FIG. 26 is a perspective view of the adjustment bracket of FIG. 22 shown attached to a portion of a log splitter assembly.

### DETAILED DESCRIPTION

The present disclosure is not limited to the particular details of the apparatus depicted, and other modifications and applications may be contemplated. Further changes may be made in the apparatus, device or methods without departing from the true spirit of the scope of the disclosure herein involved. It is intended, therefore, that the subject matter in this disclosure should be interpreted in an illustrative, not in a limiting, sense.

Log Splitter Assembly

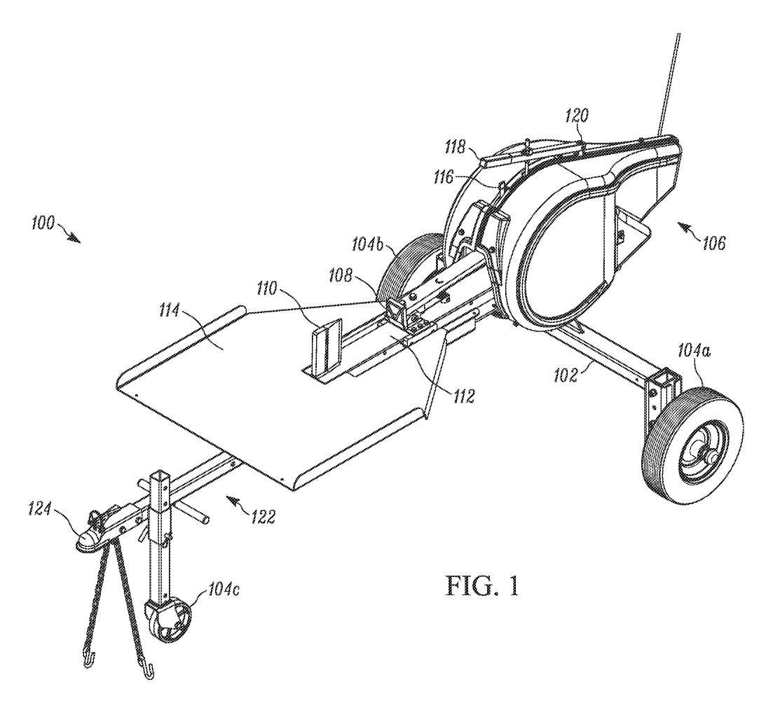

As shown in FIG. 1, in one aspect of the present disclosure, a log splitter assembly 100 includes a frame assembly 102 supported by two rear wheels 104a, 104b and a front wheel 104c. The frame assembly 102 in turn supports a housing 106 containing drive equipment that functions to move a ram 108 along an I-beam assembly 112 (the term “I-beam” shall be interpreted and construed so as to not be limited solely to an I-beam, which is but one embodiment of a structural assembly that permits the intended functionality, but rather broadly as a structural assembly that provides the intended functionality, and therefor the “I-beam assembly 112” may also be referred to herein a “structural assembly”) towards a wedge 110. In operation, a log section (not shown) is placed on the structural assembly 112. The ram 108 contacts with one side of the log section and drives the log section into the wedge 110, causing the log section to split. A work table 114 is supported by the frame assembly 102 and serves to catch and support the split portions of the log section. By placing a truck bed, cart or other raised surface substantially flush with the work table 114, a user may slide split log sections from the work table 114 onto the raised surface. This enables a user to quickly move split log sections off the work table without having to lift or carry the split log sections.

After splitting a log section, the ram 108 moves towards the housing 106. The split pieces of the log section are removed from the work table 114, and a new log section may be placed on the structural assembly 112 between the ram 108 and the wedge 110. The housing may contain one or more flywheels 304 (not shown here) which may be operatively connected to a motor 308 or other source of rotational energy, including but not limited to a crank, an electric motor, a gas-powered motor, a pressurized container or the like. As discussed herein, the one or more flywheels 304 may be operatively connected to the ram 108 so as to move the ram 108.

In an embodiment, an engagement lever 118 (also referred to as an engagement handle) is rotationally connected to the top of the housing 106 via a pivot point 120 located towards the rear of the housing 106. The engagement lever 118 may be substantially in the same longitudinal axis as the I-beam assembly 112. A safety handle 116 (also referred to as a safety lever) may be placed towards the front of the housing 106 and may be substantially perpendicular to the structural assembly 112. The bottom of the safety lever 116 may be rotationally connected to the housing 106 via a pivot point (not shown).

In an embodiment, the distance between each of the wheels 104a, 104b, 104c and the work table 114 and the top surface of the I-beam assembly 112 may be increased. This allows a user to adjust the height of the log splitter assembly 100 to one which is convenient during use, for example based on the user's height. In an embodiment, the log splitter assembly 100 is configured such that it may be moved using the wheels 104a, 104b, 104c while the log splitter assembly 100 is in either a raised or lowered position, enabling a user to transport the log splitter assembly 100 between locations without needed to adjust its height.

In an embodiment, the frame assembly 102 may be movably connected to a tow bar 122. The tow bar 122 may include a tow hitch 124 for removably connecting the log splitter assembly 100 to a vehicle. As shown, the tow bar 122 may be extended away from the housing 106 so as to allow the tow hitch 124 to be removably connected to a vehicle. The tow bar 122 may be moved beneath the work table 114 and the I-beam assembly 112 while the log splitter assembly 100 is not being towed. This allows the tow bar 122 and the tow hitch 124 to be protected from falling wood. Further, it allows the work table 114 to be placed flush with a truck bed, cart or other raised surface.

The following provides a detailed discussion of various embodiments.

Adjustable Height

In an embodiment, a log splitter assembly 100 is configured so that a user may adjust the height of the top surface 112a of the structural assembly 112 on which logs are placed (also referred to as the log support surface), thereby making the log splitter assembly 100 more ergonomic and decreasing the risk that the user will experience pain or injury from using the log splitter assembly 100. For example, a tall user may raise the height of the log support surface 112a, while a short user may lower the height of the log support surface 112a. Similarly, a user may adjust the height of the log support surface 112a to match the height of a truck, cart or other raised surface on which log sections are located or on which split log pieces will be placed.

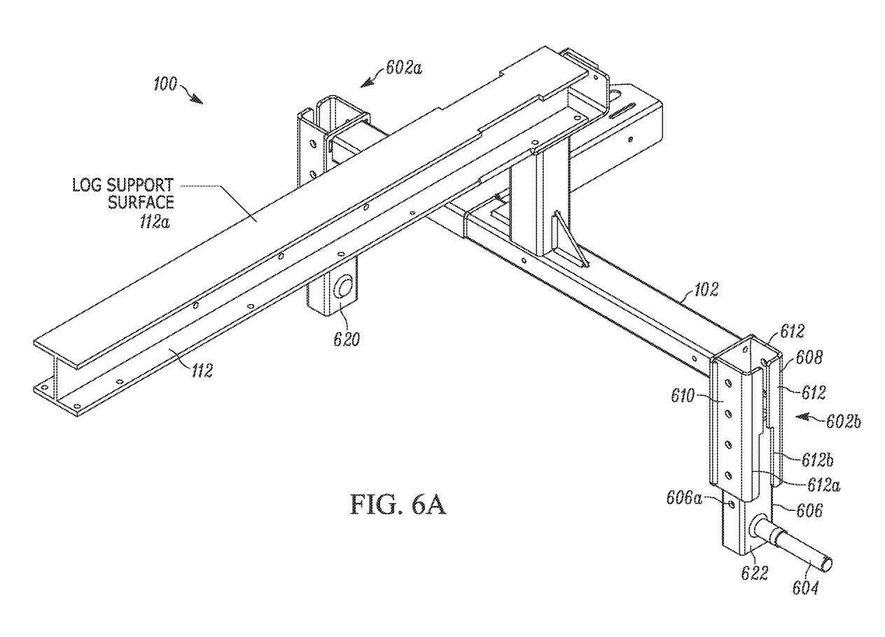

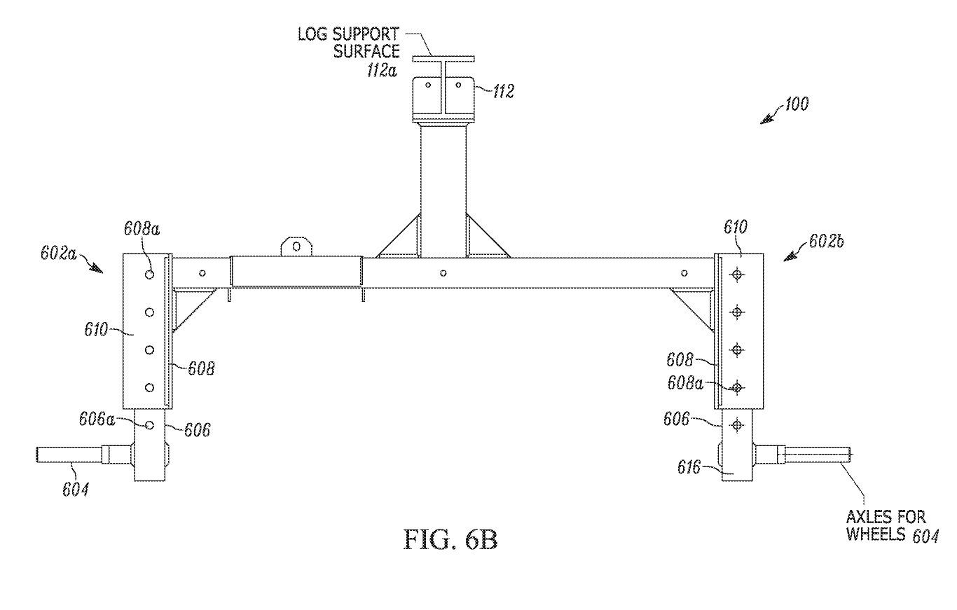

As shown in FIGS. 6A and 6B, in an embodiment, a log splitter assembly 100 is configured so that a user may adjust the height of the log support surface 112a. FIG. 6A shows a perspective view of a portion of an adjustable height log splitter assembly 100. FIG. 6B shows a front view of the portion of the adjustable height log splitter assembly 100 shown in FIG. 6A.

As shown, the I-beam assembly 112 may be connected to a frame assembly 102 which is in turn connected to a right leg assembly 602a and a left leg assembly 602b. Each leg assembly 602a, 602b may be operatively connected to a rear wheel, such as rear wheels 104a, 104b. Each leg assembly 602a, 602b comprises a horizontal wheel axle 604 which is connected to a vertical leg bracket 606 such that the horizontal wheel axle 604 is located at the lower end of the leg assembly 602a, 602b and the vertical leg bracket 606 is located at a top end of the leg assembly 602a, 602b. In an embodiment, each horizontal wheel axle 604 may be in the form of a cylinder. In an embodiment, each vertical leg bracket 606 may be in the form of a rectangular prism, with a forward surface 616 substantially parallel to a rearward surface 618 and connected to both an inner surface 620 and an outer surface 622, which surfaces are substantially parallel to one another. For each leg assembly 602a, 602b, the horizontal wheel axle 604 may extend outwardly from the outer surface 622. In an embodiment, one or more holes 606a is made in the forward surface and/or the rearward surface of each leg bracket 606. In an embodiment, matching holes 606a are made in both the forward surface and the rearward surface of each leg bracket 606. The one or more holes 606a may be made in a line extending from a location proximate to the bottom of the leg bracket 606 to a location proximate the top of the leg bracket 606. As shown in FIG. 6B, in an embodiment, the holes 606a may be spaced 2.5 inches apart. In an embodiment, the holes 606a may be placed such that the log support surface 112a may be placed at most 34 inches above the ground and at least 26.5 inches above the ground.

As shown, the frame assembly 102 includes two vertical receiving brackets 608, each of which is configured to receive one of the two leg brackets 606. In an embodiment, each of the receiving brackets 608 is substantially shaped as a hollow rectangular prism and is configured to surround a corresponding one of the leg brackets 606. In an embodiment, each receiving bracket 608 includes a front face 610, a rear face 612, and a side face 614. The side face 614 may comprise a pair of flanges 614a, 614b which are spaced apart from one another and each extend inwardly from a respective one of the front face 610 and the rear face 612.

A corresponding one or more holes 608a may be made in the forward surface, the rearward surface, or both of each of the receiving brackets 608. Accordingly, each of the leg brackets 606 may be removably connected to a corresponding one of the receiving brackets 608 by first placing the leg bracket 606 inside the receiving bracket 608 so that the holes 606a, 608a are aligned and then placing a fastener (not shown) through the holes 606a, 608a. The fastener may comprise a pin, a hex bolt or another fastener. As will be clear to one of skill in the art, another suitable type of fastener may be used. In an embodiment, the fastener may have one end that is larger than the diameter of the holes 606a, 608a. In an embodiment, the fastener is a hex bolt, and it may be secured in place using a lock washer and a hex nut. As will be clear to one of skill in the art, multiple fasteners may be used in each leg assembly 602a, 602b to more securely attach the leg bracket 606 to the receiving bracket 608.

In an embodiment, the flanges 614a, 614b extend the entire height of the side face 614 such that the side face 614 is entirely divided by a gap. In an embodiment, the lower portion of the flanges 614a, 614b may be spaced apart by a greater distance than the upper portion of the flanges 614a, 614b. This spacing between the flanges 614a, 614b permits the distance between the front face 610 and the rear face 612 to be adjusted, for example by inserting one or more fasteners into the holes 608a. By tightening the fasteners, for example by threading a hex nut onto a threaded bolt, the distance between the front face 610 and the rear face 612 may be decreased, causing the front face 610 to press against the forward surface 616 and the rear face 612 to press against the rearward surface 618. This increases the friction between the leg brackets 606 and the receiving brackets 608, further securing them together.

The distance between the ground and the log support surface may be adjusted by matching different ones of the holes 606a, 608a in the leg brackets 606 and receiving brackets 608, respectively. For example, by aligning the bottom hole 606a on the leg bracket 606 with the bottom hole 608a on the receiving bracket 608, the log support surface 112a may be placed at a first height. By aligning the bottom hole 608a of the receiving bracket 608 with the top hole 606a of the leg bracket 606, the height of the log support surface 112a may be raised to a second height which is greater than the first height.

As will be clear to one of skill in the art, other mechanisms or methods may be used to removably connect the leg brackets 606 to the receiving brackets 608 and to enable a user to adjust the height of the log support surface 112a. For example, in an embodiment, a pin may be attached to the leg bracket such that it protrudes from the exterior surface of the leg bracket. The pin may be spring loaded, such that when a user presses on the pin, the pin retracts into the leg bracket until it is substantially flush with the leg bracket. The user may then adjust the height of the log support surface by raising or lowering the leg bracket until the pin encounters a hole in the receiving bracket and pops back into the hole, removably securing the leg bracket in place.

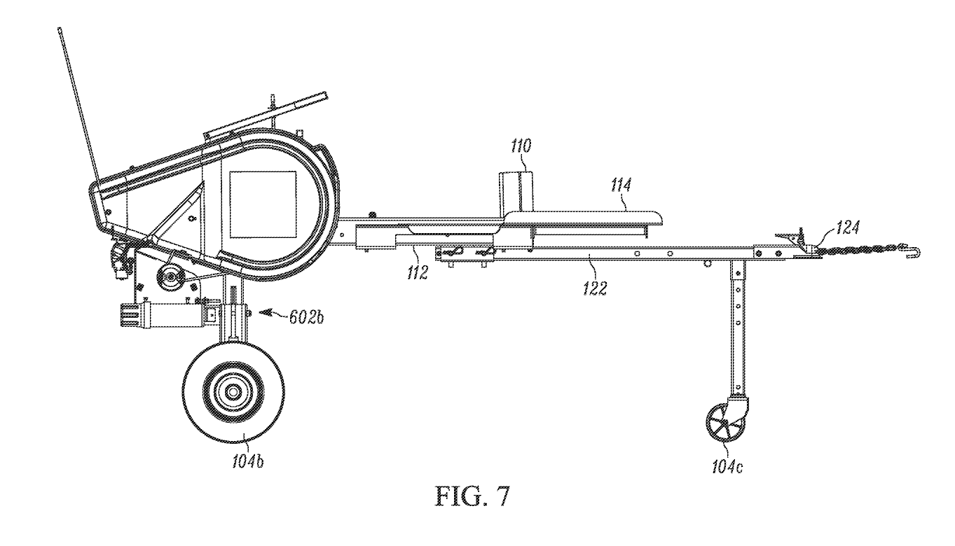

FIG. 7 shows a side view of an embodiment of a log splitter assembly with the log support surface in the highest of four positions. As shown, the distance between a front wheel and the log support surface may be adjusted similarly to the rear wheels. In an embodiment, a front wheel receiving bracket is operatively connected to the frame assembly. By aligning the bottom holes in the receiving brackets with the top holes in the leg brackets, the log support surface may be raised to a maximum height from the ground.

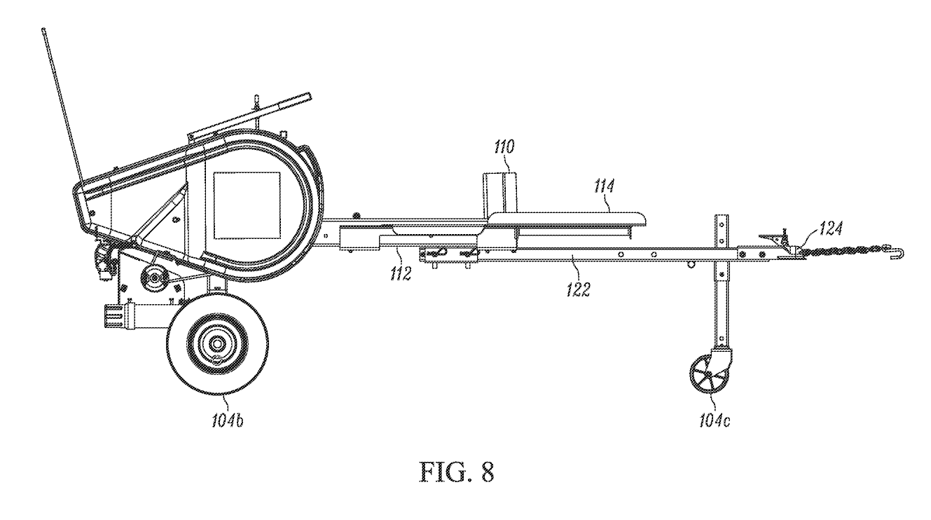

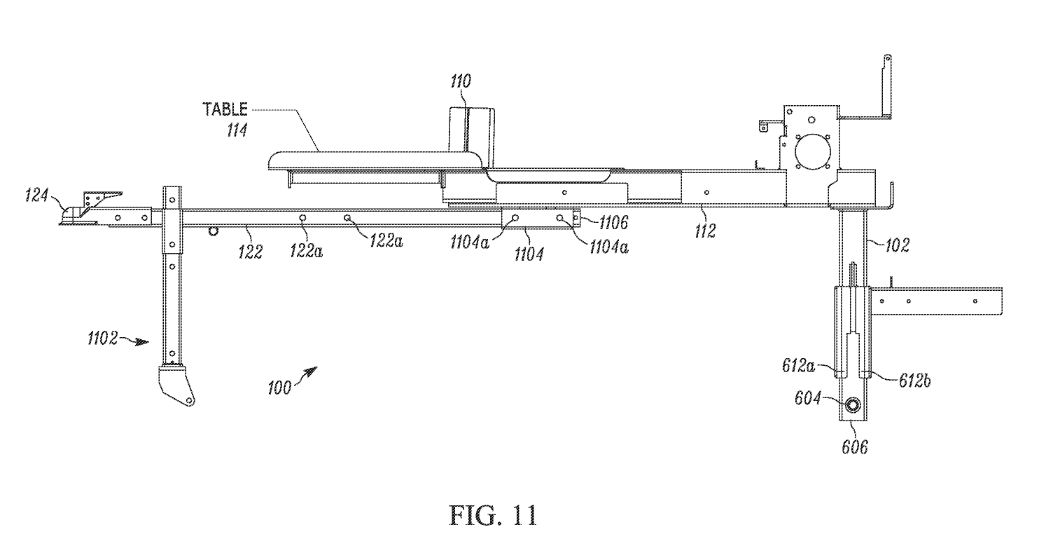

FIG. 8 shows a side view of the log splitter assembly of FIG. 7 with the log support surface in the lowest of four positions. As shown, the bottom holes in the receiving brackets may be aligned with the bottom holes in the leg brackets. The log support surface is thereby lowered closer to the ground. As shown, for example in FIG. 11, the space between the flanges 612a, 612b is such that the horizontal wheel axle 604 passes between the flanges 612a, 612b when the log support surface is in the lowest position.

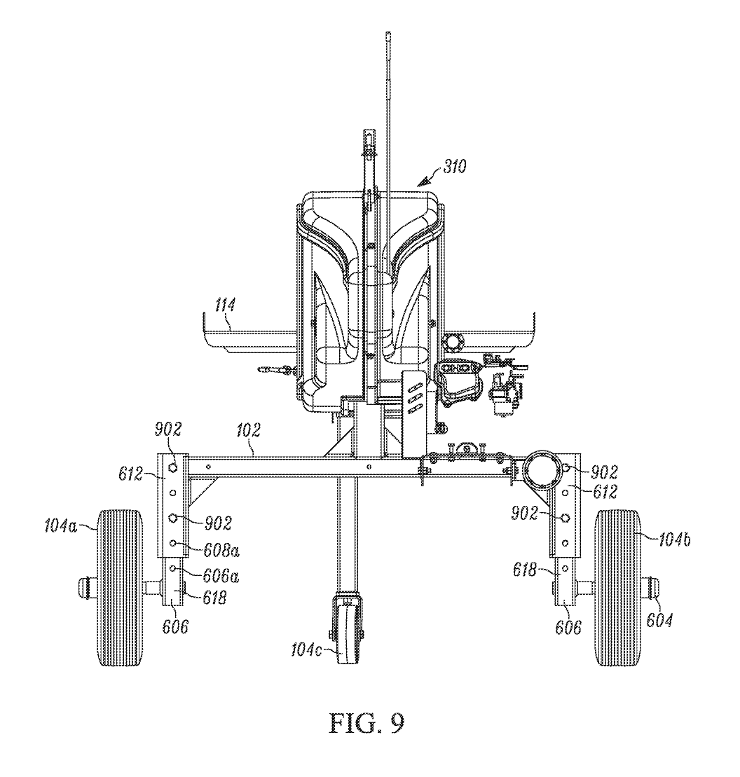

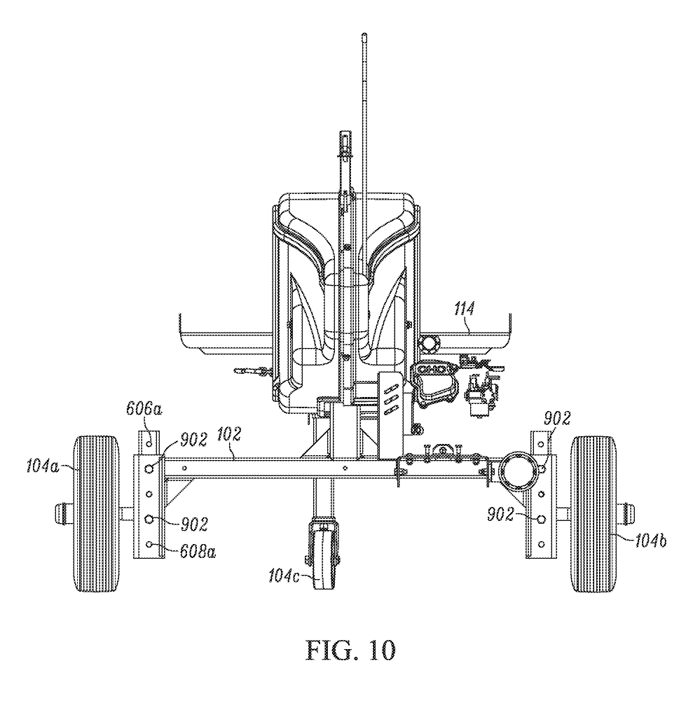

FIG. 9 shows a rear view of the log splitter assembly of FIG. 7. FIG. 10 shows a rear view of the log splitter assembly of FIG. 8. As shown, in an embodiment, two fasteners 902 secure the right leg assembly 602a to the frame assembly 102, and two fasteners 902 secure the left leg assembly 602b to the frame assembly 102. In certain positions where the log support surface 112a is closer to the ground, the horizontal wheel axle 604 protrudes between the flanges 612a, 612b.

Retractable Tow Bar

To enable a log splitter assembly 100 to be easily transported between locations, it may be configured to be towed behind a vehicle, such as a truck. In an embodiment, a log splitter assembly 100 is configured to include a tow bar 122, which extends from the front of the log splitter assembly 100 and may be removably attached to a vehicle for towing. While the log splitter is in use, the tow bar 122 may be stowed beneath the I-beam assembly 112. In this way, the front end of the log splitter assembly 100 may be located closer to a vehicle or other raised surface to enable a user to easily transfer log sections from the raised surface to the log support surface 112a or to transfer split log pieces from the work table 114 to the raised surface. Additionally, this protects the tow bar 122 from damage in the event that pieces of wood fall from the work table 114 or the log support surface 112a.

FIG. 11 shows a side view of a portion of a log splitter assembly 100 with a tow bar 122 in an extended position. As shown, the tow bar 122 is operatively connected to the bottom of the I-beam assembly 112. The front wheel assembly 1102 may be operatively attached to the tow bar 122. The front end of the tow bar 122 may be configured to attach to a vehicle, for example by using a tow hitch 124. When extended, the tow bar 122 separates the front ends of the structural assembly 112 and the work table 114 from the rear end of the vehicle by a sufficient distance to allow the log splitter assembly 100 to be safely towed.

As shown, the tow bar 122 may be slidably attached to the I-beam assembly 112 by a tow bar receiving bracket 1104.

In an embodiment, the tow bar receiving bracket 1104 comprises a hollow rectangular prism with two lateral sides and a bottom surface in the shape of a U. In an embodiment, the tow bar receiving bracket 1104 comprises a hollow rectangular prism with two lateral sides, a bottom surface and a top surface. The tow bar receiving bracket 1104 may be secured to or integral to the I-beam assembly 112 by either the lateral sides, the top surface or both. The tow bar receiving bracket 1104 may be sized so as to receive the tow bar 122 in the space surrounded by the lateral sides, the bottom surface, and either the top surface of the receiving bracket 1104 or the bottom surface of the I-beam assembly 112.

In an embodiment, one or more bearings (not shown) may be placed so as to enable the tow bar 122 to easily slide along the structural assembly 112. In an embodiment, the bearings are operatively attached to either the top surface of the tow bar 122, the bottom surface of the I-beam assembly 112 or the interior of the top surface of the tow bar receiving bracket 1104. In an embodiment, the bearings are operatively attached to either the bottom surface of the tow bar 122 or the interior of the bottom surface of the tow bar receiving bracket 1104. In an embodiment, the bearings are operatively connected to the tow bar receiving bracket 1104. In an embodiment, bearings are placed on the interior of both the top surface of the tow bar receiving bracket 1104 and the bottom surface of the tow bar receiving bracket 1104.

In an embodiment, the tow bar 122 is surrounded by the tow bar receiving bracket 1104. One or more holes 1104a may be made in either the right surface or the left surface of the tow bar receiving bracket 1104. In an embodiment, corresponding holes 1104a are made in both the right surface and the left surface. One or more corresponding lateral holes 122a may be made in the tow bar 122. In an embodiment, a series of holes 122a are made in a horizontal line along the length of the tow bar 122. The tow bar 122 may be secured to the I-beam assembly 112 by aligning one or more holes 122a in the tow bar 122 with one or more holes 1104a in the tow bar receiving bracket 1104 and inserting a fastener (not shown) into the aligned holes 122a, 1104a. The fastener may comprise a hex bolt, a pin or another type of fastener. The fastener may be secured in placing using a hex nut, by inserting a hair cotter pin through a hole in the end of the fastener. As will be clear to one of skill in the art, another suitable method of securing the fastener may be used.

In an embodiment, a pair of holes 1104a is made in the tow bar receiving bracket 1104. Corresponding pairs of holes 122a are placed near the front end of the tow bar 122 and the rear end of the tow bar 122. The tow bar 122 may be secured in an extended position by aligning the pair of holes 122a near the rear of the tow bar 122 with the pair of holes 1104a in the tow bar receiving bracket 1104 and inserting fasteners into the aligned holes 122a, 1104a.

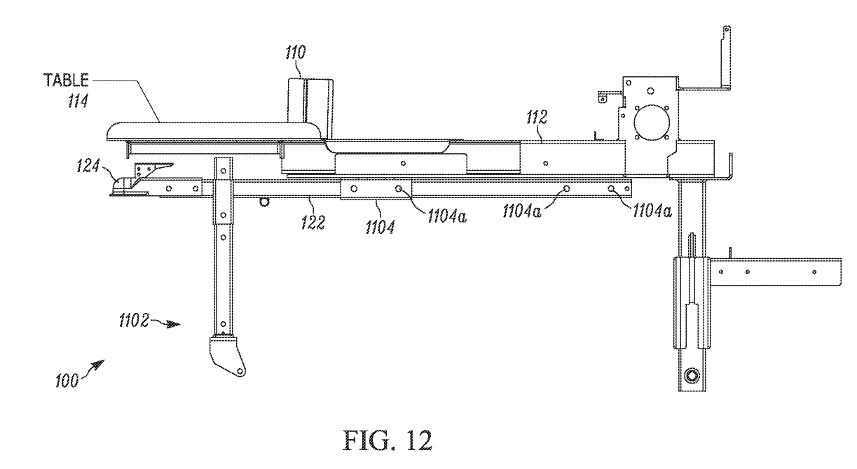

FIG. 12 shows the portion of a log splitter assembly shown in FIG. 11 in a retracted position. As shown, the tow bar 122 may be secured in the retracted position by aligning the pair of holes 122a near the front of the tow bar 122 with the corresponding pair of holes 1104a in the tow bar receiving bracket 1104 and inserting fasteners into the aligned holes 122a, 1104a.

In an embodiment, a hole 1106 runs through the tow bar 122 near the rear of the tow bar 122. A bolt or other fastener may be placed through the hole 1106 and secured so as to extend away from the tow bar 122 on at least one side of the tow bar 122. The bolt or fastener thereby prevents the tow bar 122 from being completely removed from the tow bar receiving bracket 1104.

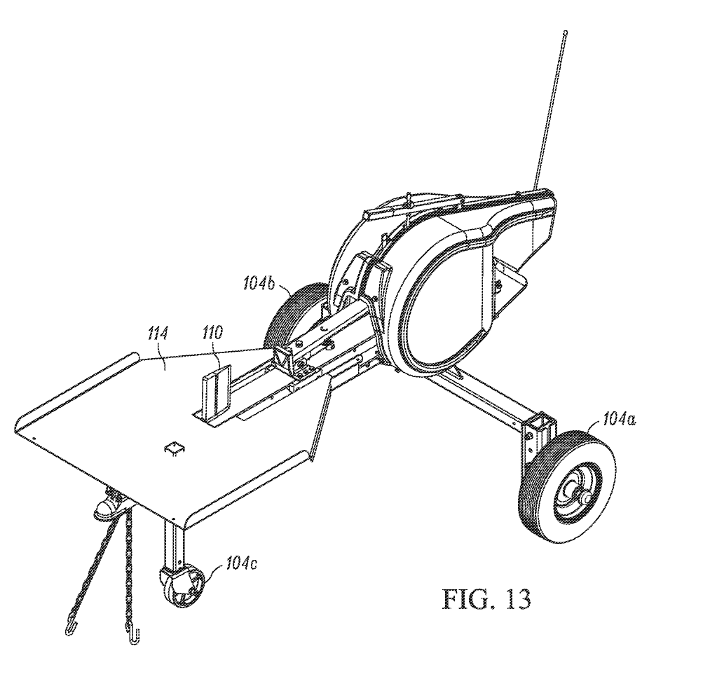

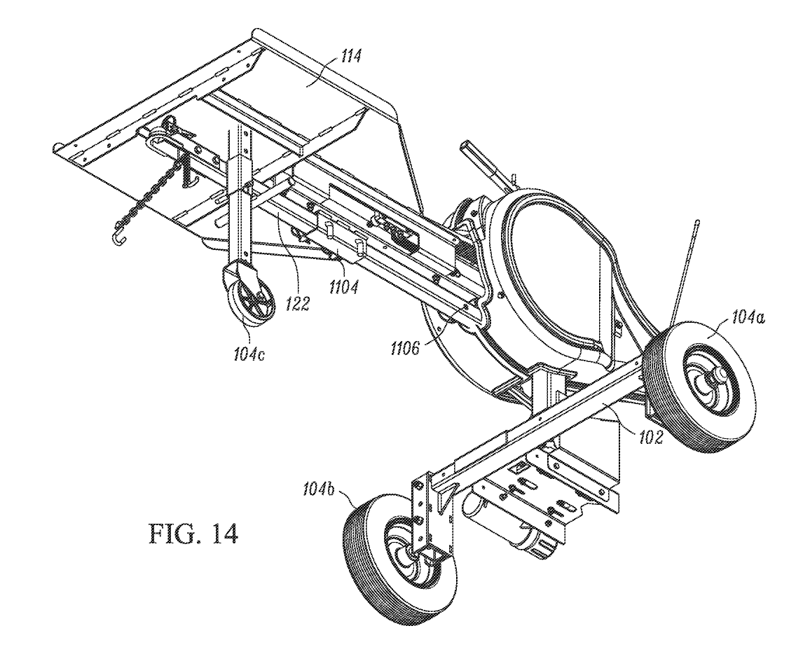

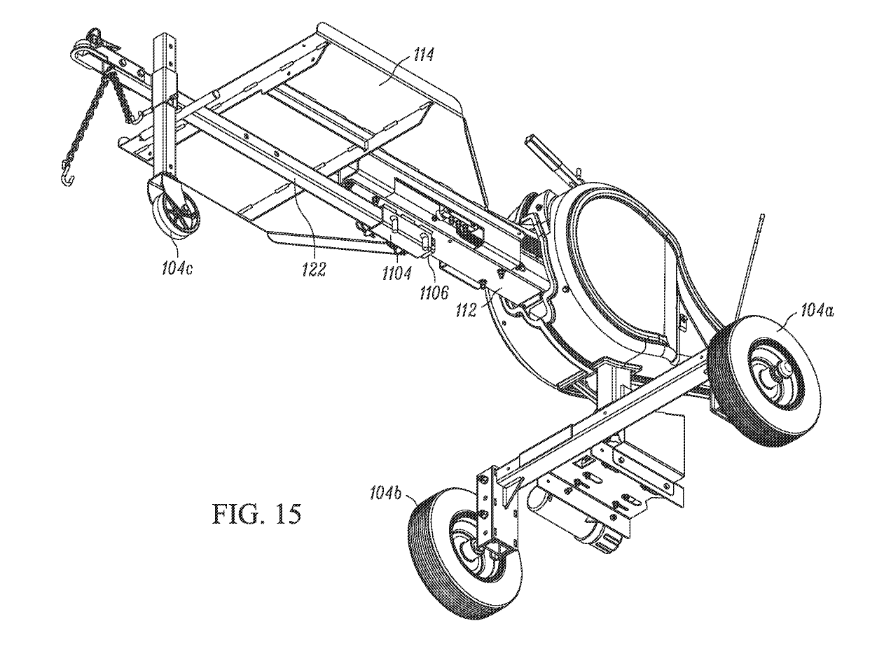

FIGS. 13 and 14 show perspective views of a log splitter assembly with the tow bar in a retracted position. FIG. 15 shows a perspective view of a log splitter assembly with the tow bar in an extended position.

Two-Handed Operation

When a user can engage a log splitter using only one hand, there is a possibility that the user may place the user's free hand between the ram and the wedge. When the log splitter is engaged, the user's free hand may become injured. As will be clear to one of skill in the art, a user may injure his or her free hand in a variety of other ways while engaging a log splitter using only one hand. Accordingly, in an embodiment, a log splitter assembly 100 is configured to increase the safety of a user by requiring the user to employ two hands to engage the log splitter assembly 100.

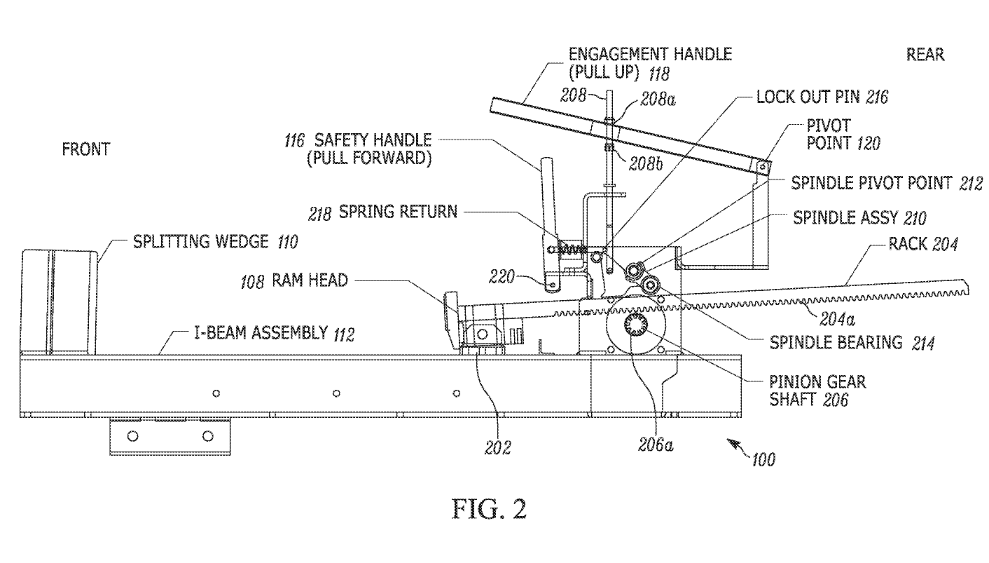

FIG. 2 shows a simplified cross section of a log splitter assembly 100 configured for two-handed operation in accordance with an embodiment of the invention. The log splitter assembly 100 includes a splitting wedge 110 adjacent to the top surface of an I-beam assembly 112. Optionally, the front end of the splitting wedge 110 may be located flush with the front end of the structural assembly 112. The rearward end of the splitting wedge 110 may be narrow and is configured to split a log section when the log section is pressed into the rear end of the splitting wedge 110. The ram 108 (also referred to herein as a ram head) is initially located adjacent to the top surface of the I-beam assembly 112 to the rear of the I-beam assembly 112 in relation to the splitting wedge 110. During operation, a log section is placed between the ram head 108 and the splitting wedge 110, and the ram head 108 is moved towards the splitting wedge 110. The log section is thereby pressed into the splitting wedge 110 by the ram head 108 and is split. The ram head 108 may be supported by a ram head slider 202, which is configured to move along the top surface of the I-beam assembly 112. The ram head 108 is operatively connected to a rack 204, which is located to the rear of the log splitter assembly 100 from the ram head 108. A pinion gear shaft 206 is operatively connected to a motor 308 or other source of rotational energy (not shown) and is configured to rotate. The pinion gear shaft 206 may be operatively connected to the motor 308 via one or more flywheels 304 (not shown here). While not in use, a rack support spring 302 (not shown here) lifts the rack 204 above the pinion gear shaft 206 so that the rack 204 is not in contact with the pinion gear shaft 206.

An engagement handle 118 is located proximate to the top of the log splitter assembly 100. The engagement handle 118 is positioned substantially in line with the longitudinal axis of the log splitter assembly 100. The engagement handle 118 has a forward end and a rearward end. The forward end of the engagement handle 118 is free, while the rearward end is rotationally connected to a pivot point 120 towards the rear of the log splitter assembly 100. An engagement rod 208 operatively connects the engagement handle 118 to a spindle assembly 210, located between the engagement handle 118 and the rack 204. The engagement rod 208 may run substantially vertically between the engagement handle 118 and the spindle assembly 210. In an embodiment, the engagement rod 208 is connected to the engagement handle 118 by passing through holes in the bottom and top surfaces of the engagement handle 118, as indicated by the dashed lines in FIG. 2. The top of the engagement rod 208 may include enlarged portions 208a and 208b located above and below the engagement handle 118, respectively. The enlarged portions 208a, 208b may each comprise a washer and a hex nut. The engagement rod 208 is thereby movably attached to the engagement handle 118.

The bottom end of the engagement rod 118 is operatively attached to the forward portion of the spindle assembly 210. The spindle assembly 210 is located above and adjacent to the rack 204 such that the rack 204 is between the spindle assembly 210 and the pinion gear shaft 206. The spindle assembly 210 may rotate around a spindle pivot point 212. In an embodiment, the spindle pivot point 212 is located in the central portion of the spindle assembly 210. The spindle assembly 210 includes a spindle bearing 214, which is located towards the bottom and rear of the spindle assembly 210 and is adjacent to the rack 204. As discussed herein, the pinion gear shaft 206 is operably attached to a motor 308 or other source of rotational energy. As viewed in FIG. 2, the pinion gear shaft 206 rotates in a counterclockwise direction.

By lifting the forward end of the engagement handle 118 such that the forward end rotates towards the rear of the log splitter assembly 100, the engagement rod 208 is raised and the spindle assembly 210 rotates clockwise. As the spindle assembly 210 rotates, the rack 204 is forced into contact with the spinning pinion gear shaft 206 by downward pressure from the spindle bearing 214.

Thus, the engagement handle 118 must be “pulled upward” to activate the log splitter assembly 100, thereby increasing the safety and comfort for an operator of the log splitter assembly 100. For example, if there is kickback on the engagement handle 118 while an operator's hand is on the engagement handle 118, the engagement handle 118 will pull “down” and away from the operator's hand rather than driving into the operator's hand. As such, the present design reduces the risk of injury to an operator's hand and/or wrist by reducing or eliminating the possibility of the engagement handle 118 being suddenly thrust into the operator's hand and/or wrist during operation.

A lock out pin 216 located above the spindle assembly 210 prevents the spindle assembly 210 from rotating until the lock out pin 216 has been removed. The lock out pin 216 is connected to a safety handle 116 and is held in place above the spindle assembly 210 by a spring return 218. In an embodiment, the safety handle 116 is oriented substantially perpendicular to the structural assembly 112 while the log splitter assembly 100 is not in use. The top end of the safety handle 116 is free, while the bottom end of the safety handle 116 is attached to a pivot point 220. To remove the lock out pin 216 from the path of the spindle assembly 210, the user must pull the top end of the safety handle 116 forward against the force of the spring return 218, causing the safety handle 116 to rotate forward around the pivot point 220. As the safety handle 116 rotates, the lock out pin 216 is pulled forward, away from the spindle assembly 210. While holding the safety handle 116 rotated forward, the user must pull up on the forward end of the engagement handle 118, thereby forcing the rack 204 into contact with the pinion gear shaft 206 and activating the log splitter assembly 100.

In an embodiment, the safety handle 116 and/or the engagement handle 118 may include a shock-absorbing coating 116a, 118a or a polycoating on the terminal portions of the safety handle 116 and/or the engagement handle 118. In an embodiment, this shock-absorbing coating 116a, 118a may be in the form of a rubber or other shock-absorbing material that covers the portion(s) of the safety handle 116 and/or the engagement handle 118 that will be gripped by an operator's hand during use. In this way, the safety handle 116 and/or the engagement handle 118 may comprise polyhandles. The use of this shock-absorbing coating 116a, 118a may reduce the force transferred to the operator's hand, for example if one of the handles 116a, 118a kicks back during operation. In an embodiment, all or a portion of the safety handle 116 and/or the engagement handle 118 may be made from a shock absorbent material. The shock absorbent material may be in the form of a rubber or other shock-absorbing material that serves to reduce the force transmitted from the safety handle 116 and/or the engagement handle 118 to the operator's hand. In an embodiment, the safety handle 116 and/or the engagement handle 118 are made from a shock absorbent material and are also provided with a shock-absorbing coating 116a, 118a on the terminal portions thereof. In this embodiment, the combination of shock absorbing materials in the handle with the shock absorbing coating serves to further reduce the force transferred to the operator's hand.

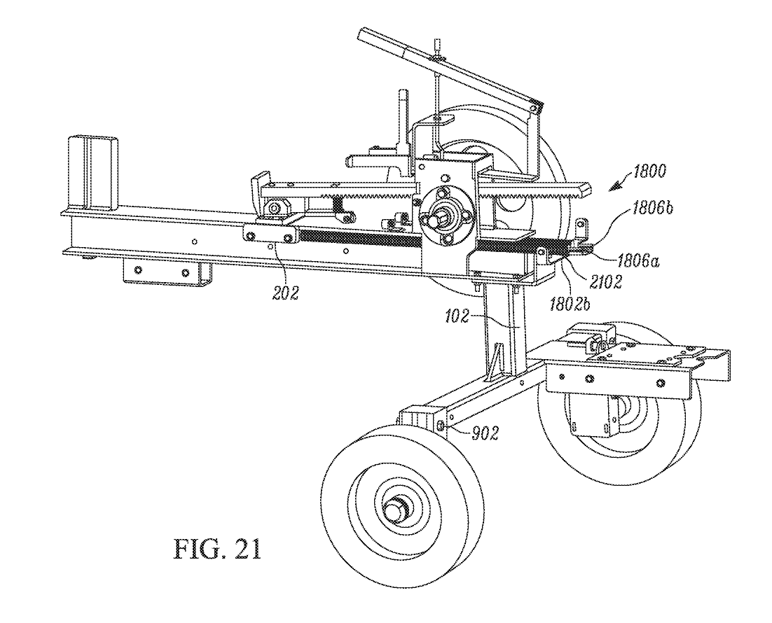

As the rack 204 is forced into contact with the pinion gear shaft 206, teeth 204a located on the underside of the rack 204 engage with teeth 206a located on the pinion gear shaft 206, and the ram head 108 is propelled forward as the pinion gear shaft 206 rotates. Once the log section has split, the user lowers the engagement handle 118. In an alternative embodiment, the user may simply release the engagement handle 118. Optionally, a spring (not shown) may be operatively connected to the engagement rod 208 so as to apply a downward force to the engagement rod 208. This spring may cause the engagement rod 208 and the engagement handle 118 to lower once the user releases the engagement handle 118. Lowering or releasing the engagement handle 118 rotates the spindle assembly 210 counterclockwise, moving the spindle bearing 214 away from the rack 204 and removing the downward pressure from the rack 204. The rack support spring 302 lifts the rack 204 away from the pinion gear shaft 206, causing the teeth 204a on the bottom of the rack 204 to disengage from the corresponding teeth 206a on the pinion gear shaft 206. A rack retention spring (not shown here but depicted in FIG. 21 as 2102) then pulls the ram head 108 back to its original position. As the engagement handle 118 lowers, the spring return 218 pushes the lock out pin 216 back into place above the spindle assembly 210, and the log splitter assembly 100 is reset.

As will be clear to one of skill in the art, a user must place one hand on the safety handle 116 and one hand on the engagement handle 118 in order to activate the log splitter assembly 100. This ensures that the user's hands are in safe locations when the log splitter assembly 100 is activated. Further, the likelihood that the log splitter assembly 100 will be activated unintentionally is reduced. Accordingly, the safety of the user is increased.

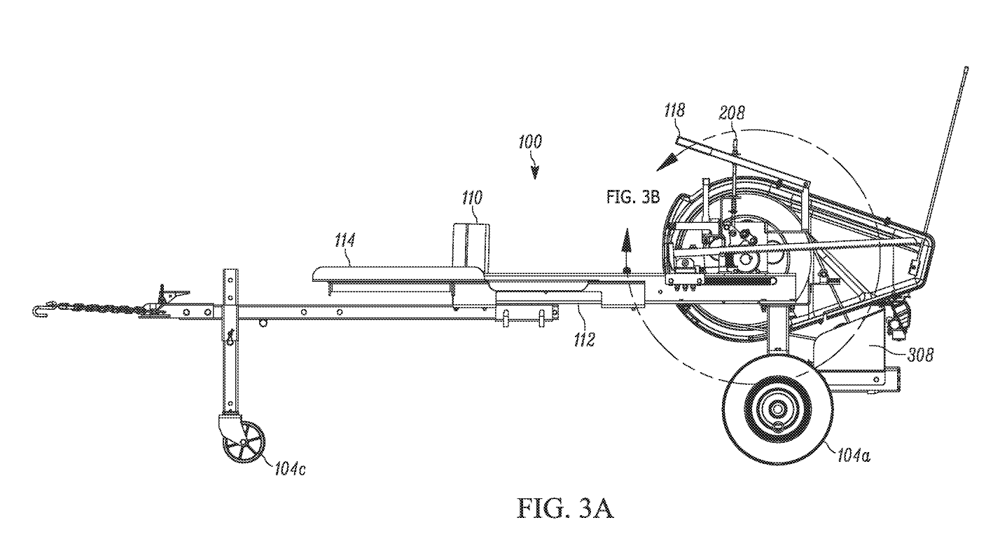

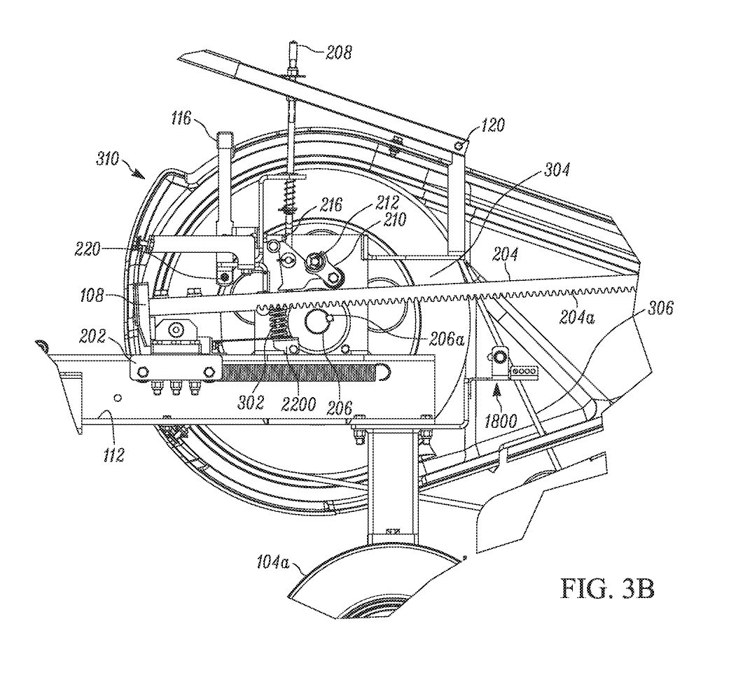

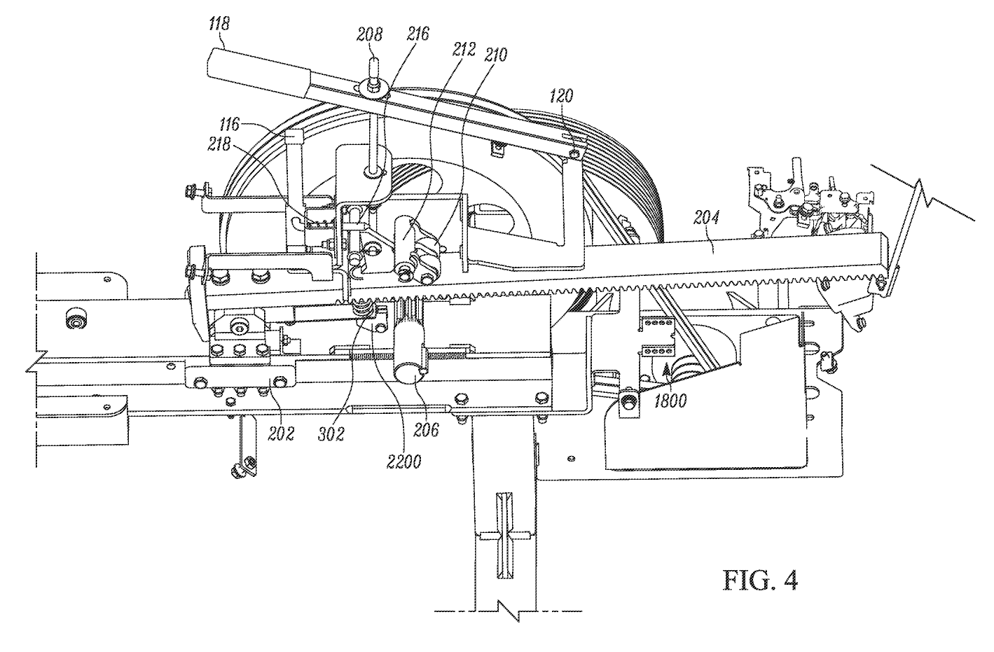

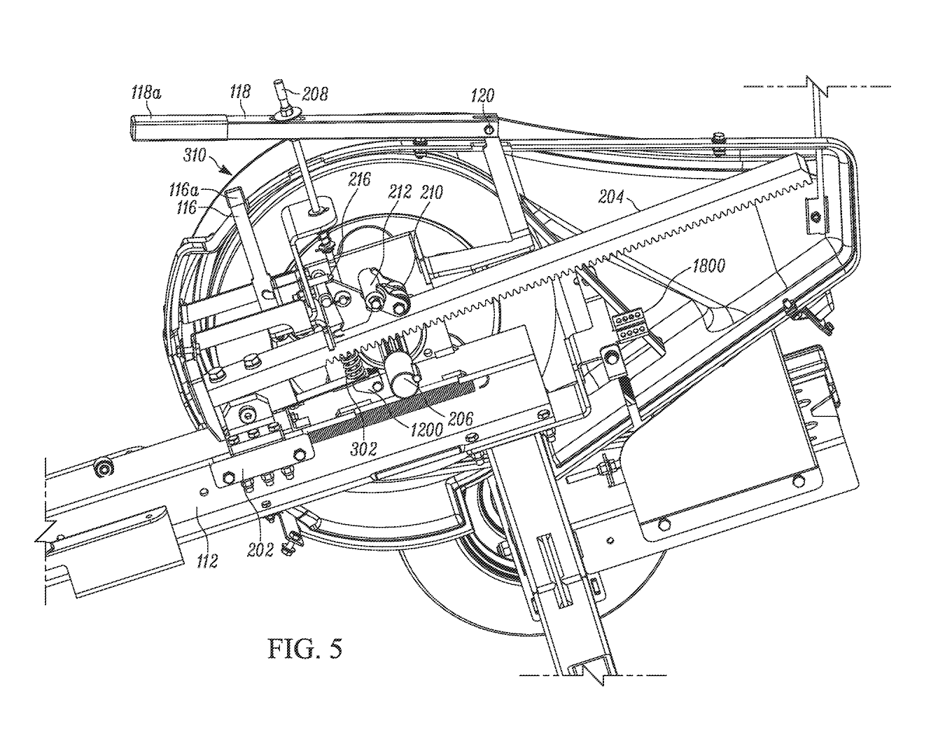

FIG. 3A shows a detailed cross section of a log splitter assembly configured for two-handed operation, while FIG. 3B shows a detailed cross section of the portion of the log splitter assembly indicated by the line A in FIG. 3A. FIGS. 4 and 5 show detailed perspective views of the portion of the log splitter assembly shown in FIG. 3B.

As shown in FIGS. 3A through 5, a rack support spring 302 may be operatively connected to both the ram head slider 202 and the structural assembly 112. Bearings may be located beneath and operatively attached to the ram head slider 202 so as to enable the ram head slider 202 to move smoothly along the top surface of the I-beam assembly 112. The pinion gear shaft 206 may be operatively connected to one or more flywheels 304. Each of the one or more flywheels 304 may be operatively connected by a belt 306 to a motor 308 or other source of rotational energy. By moving the belt 306, the motor 308 may rotate the one or more flywheels 304. As shown, a frame 310 may be used to support the engagement handle 118, the safety handle 116, the spindle assembly 210 and the other elements of the log splitter assembly 100 in the desired positions. As will be clear to one of skill in the art, the motor 308 will be activated prior to engaging the log splitting assembly 100.

When activating the log splitter assembly 100, the user must stand adjacent to and within reach of both the engagement handle 118 and the safety handle 116. As the user must not be positioned between the ram head 108 and the splitting wedge 110, the user generally will be positioned on either the right side or the left side of the log splitter assembly 100. In other words, a user may stand on either side of the log splitter assembly 100 when activating the log splitter assembly 100 due to the substantially symmetric configuration of the log splitter assembly 100.

Exploded Views of a Log Splitter Assembly

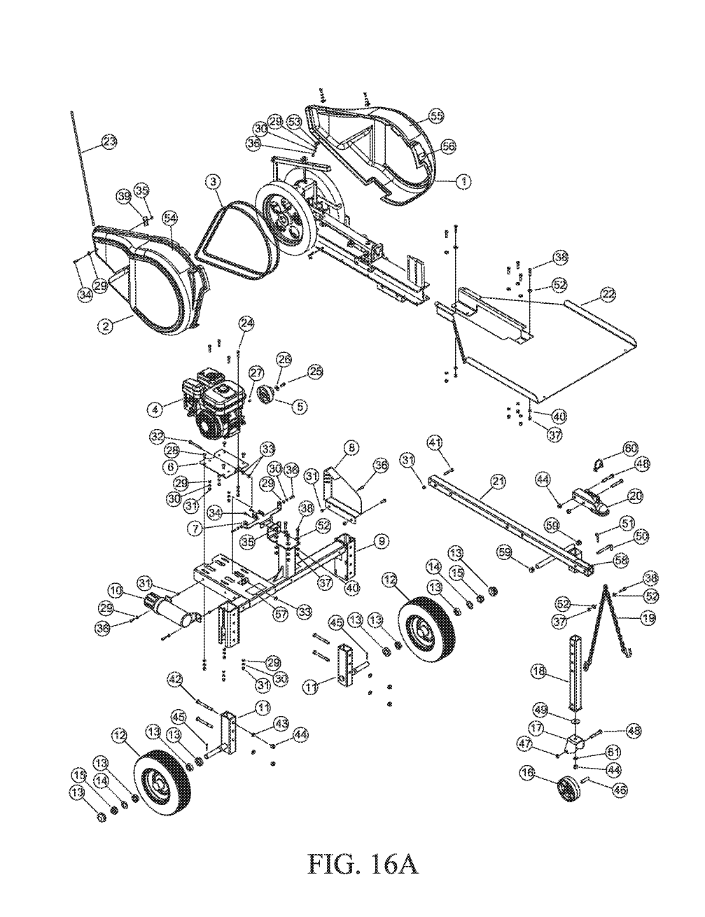

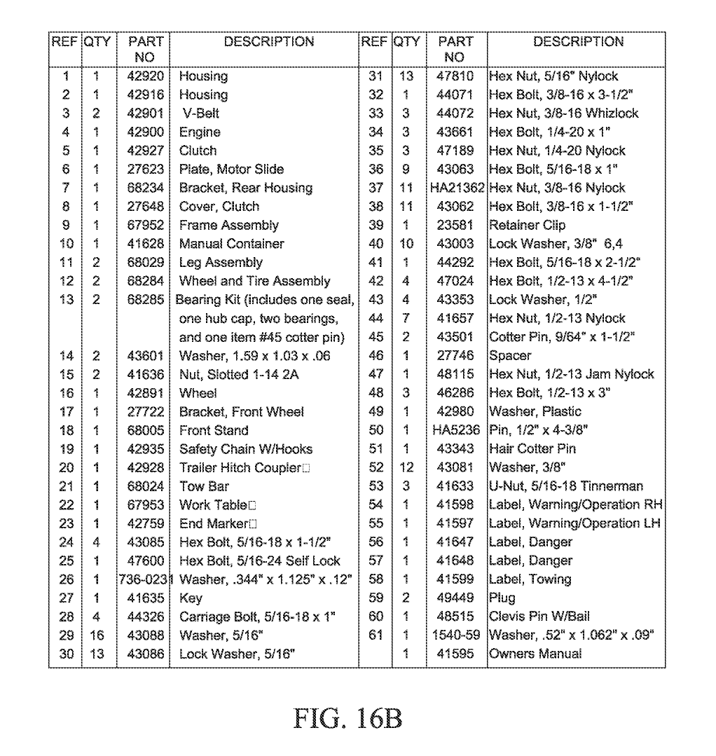

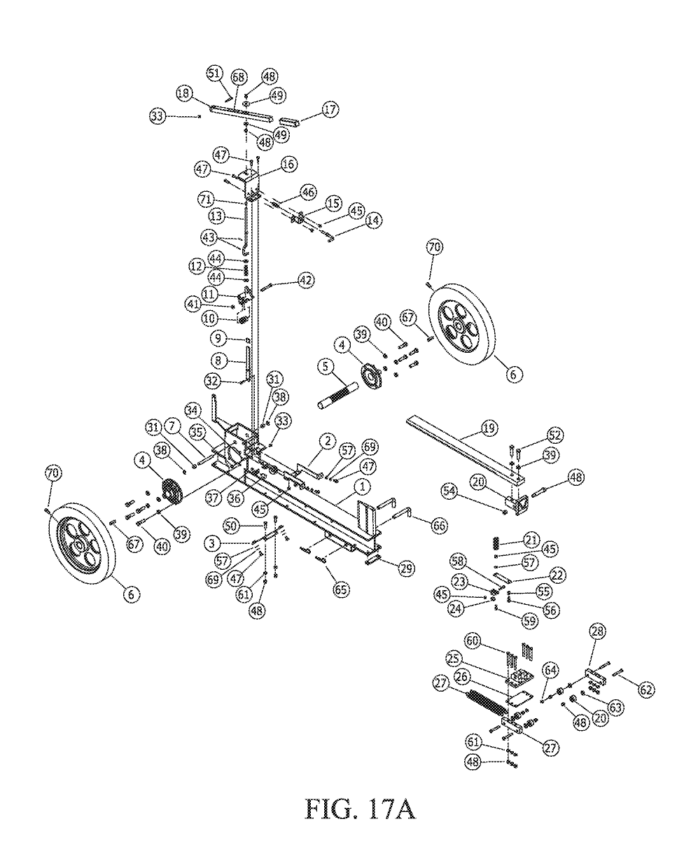

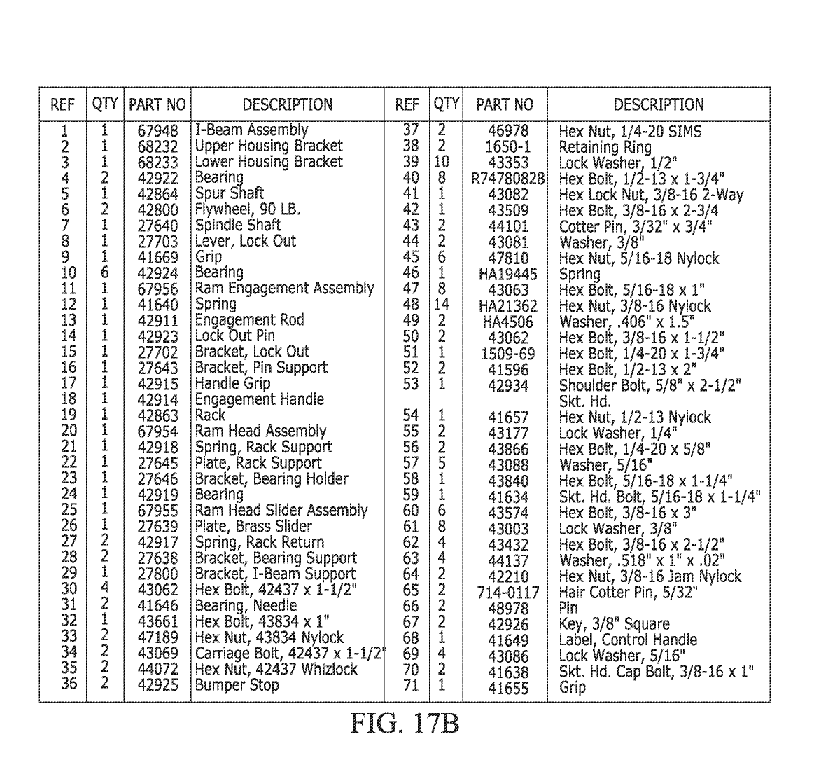

FIGS. 16 and 17 depict exploded views of a log splitter assembly in accordance with an embodiment in accordance with the present invention. FIG. 16 depicts the frame assembly and assorted parts, while FIG. 17 depicts the portion of the log splitter assembly shown in broken lines in FIG. 16, including the structural assembly, wedge, ram and assorted parts. FIGS. 16 and 17 each include a legend detailing the parts shown in the respective figure. As will be clear to one of skill in the art, other parts may be used, and not all parts shown are required. Part numbers shown in FIG. 16 do not necessarily relate to part numbers shown in FIG. 17. Similarly, the part numbers shown in FIGS. 16 and 17 do not necessarily relate to the reference numbers used elsewhere in this disclosure.

Retraction Spring and Adjustment Bracket

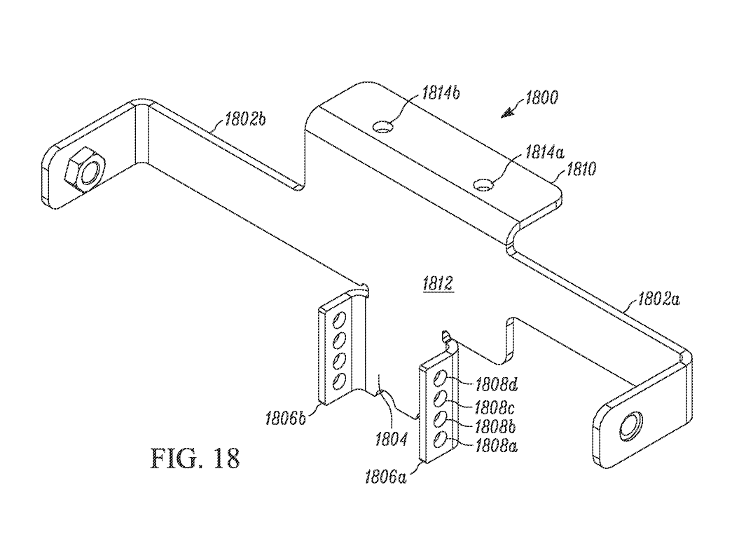

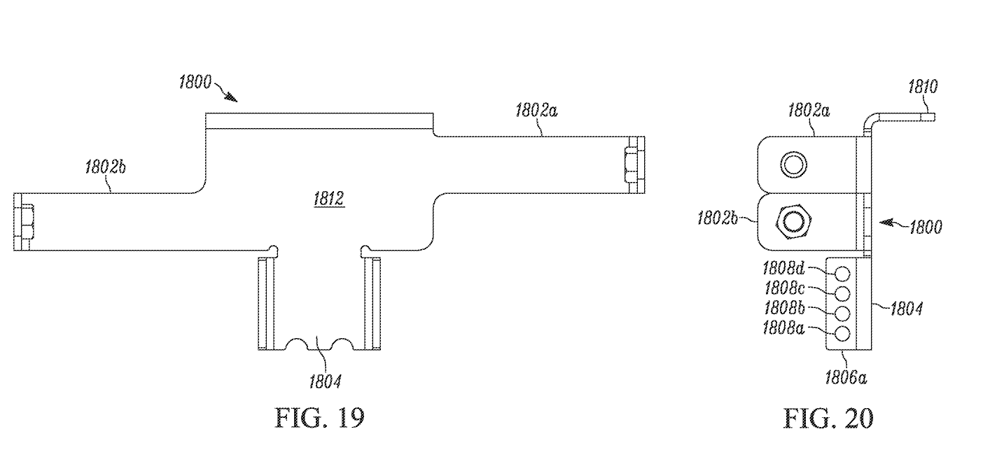

As shown in FIGS. 18-21, in an embodiment, a log splitter assembly 100 includes an adjustment bracket 1800. The adjustment bracket 1800 comprises an adjustment bracket body 1812 with a pair of laterally extending arms 1802a, 1802b and a spring mount portion 1804 with two spring mount flanges 1806a, 1806b which extend perpendicular to the spring mount portion 1804. Each spring mount flange 1806a, 1806b comprises a plurality of spring mount openings 1808a, 1808b, 1808c, 1808d. In an embodiment, four spring mount openings 1808a, 1808b, 1808c, 1808d are spaced equidistantly along each spring mount flange 1806a, 1806b in a longitudinal direction. As will be clear to one of skill in the art, a different number of spring mount openings could also be used. A frame mount flange 1810 extends perpendicularly away from the adjustment bracket body 1812 and may comprise one or more openings 1814a, 1814b.

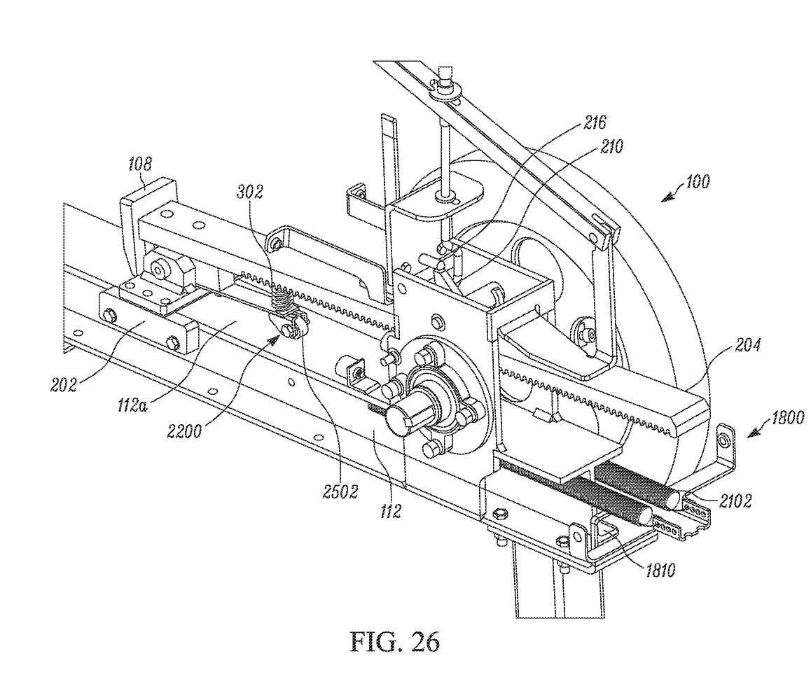

As shown in FIGS. 21 and 26, the adjustment bracket 1800 is attached to the frame assembly 102 via the frame mount flange 1810. One or more retraction springs 2102 run between the ram head slider 202 and a respective one of the spring mount flanges 1806a, 1806b. As shown, in an embodiment, two retraction springs 2102 may be used.

In an embodiment, each retraction spring 2102 is initially attached to a respective one of the spring mount flanges 1806a, 1806b via the spring mount opening 1808d closest to the ram head slider 202. Over time, the refraction springs 2102 may degrade such that the tension in the retraction springs 2102 decreases. As discussed above, the retraction springs 2102 function to return the ram head 108 to its original position during use. As tension in the rack retention springs 2102 decreases, the ram head 108 may not be returned to its original position, preventing the log splitter assembly 100 from properly resetting between uses. Tension in the retraction springs 2102 may be increased by moving them to the next spring mount opening 1808c that is farther from the ram head slider 202 in the longitudinal direction. In this way, tension in the retraction springs 2102 may be increased multiple times to account for gradual wear, thereby prolonging the life of the log splitter assembly 100 and decreasing the frequency with which the retraction springs 2102 will need to be replaced.

Housing Bracket for Ram Return Bearing

In an embodiment, a log splitter assembly 100 includes a housing bracket 2200. As shown in FIG. 26, in an embodiment, the housing bracket 2200 may be connected to the ram head slider 202 beneath the rack support spring 302.

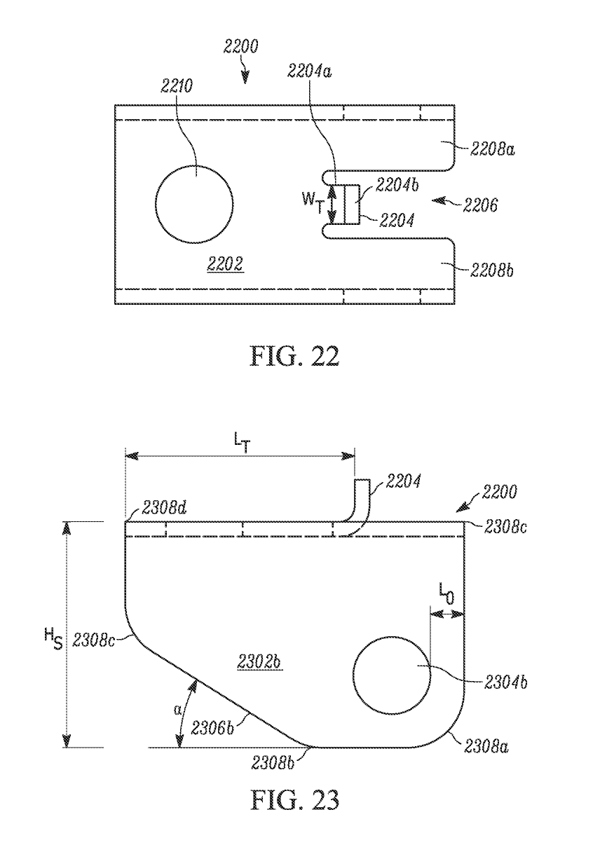

As shown in FIG. 22, the housing bracket 2200 may include a top surface 2202 with an opening 2210 in the forward part of the top surface 2202 for attaching the housing bracket 2200 to a log splitter assembly. The rear portion of the top surface 2202 includes a notch 2206 in the central portion thereof, with two lateral protrusions 2208a and 2208b along the sides of the notch 2206. The notch 2206 surrounds a tang 2204 which extends perpendicular to the top surface 2202 in an upward direction, such that portions of the notch 2206 separate the tang 2204 from the lateral protrusions 2208a, 2208b. The tang 2204 may comprise a ninety-degree bend, such that the base 2204a of the tang 2204 is substantially flush with the top surface 2202 while the tip 2204b of the tang 2204 is substantially perpendicular to the top surface 2202.

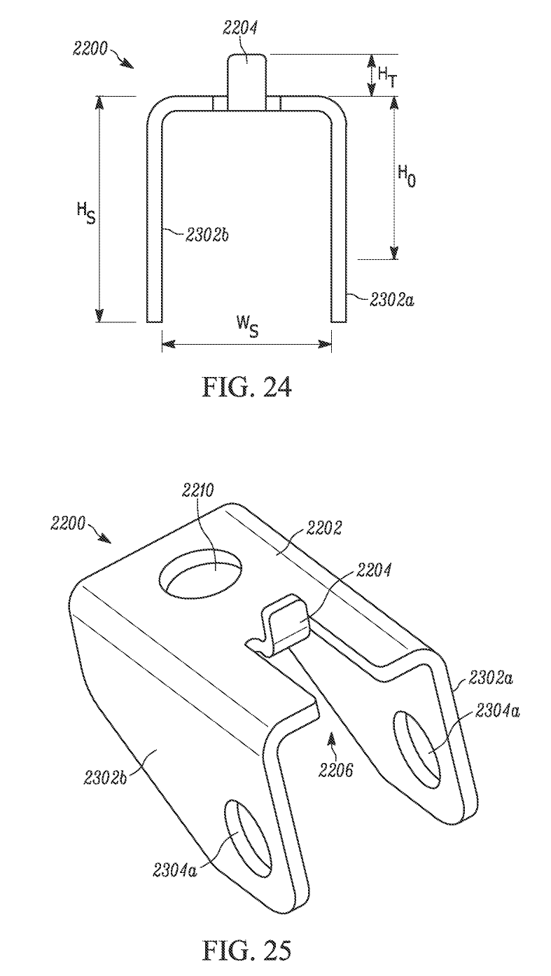

As shown in FIGS. 23-25, the housing bracket 2200 may include lateral surfaces 2302a, 2302b which extend perpendicularly downward from the top surface 2202. The lateral surfaces include openings 2304a, 2304b which allow an axle and fastening means (not shown) to extend between the lateral surfaces 2302a, 2302b and secure a bearing (not shown) therebetween. The leading edges 2306a, 2306b of the lateral surfaces 2302a, 2302b may be at an angle α to the horizontal plane formed by the top surface 2202. In an embodiment, the angle α may be between 25 and 45 degrees. In an embodiment, the angle α is 32 degrees.

The lower corners 2308a, 2308b, 2308c of the lateral surfaces 2302a, 2302b may be rounded, while the upper corners 2308d, 2308e may form right angles. In an embodiment, the curves may form portions of the circumference of a circle with a radius of ¼th of an inch.

In an embodiment, the opening 2210 in the top surface 2202 and the openings 2304a, 2304b in the lateral surfaces 2302a, 2302b may be circular with a diameter of 0.34 inches.

In an embodiment, the distance L_{T} between the front of the top surface 2202 and the front of the tang 2204 may be between 1 and 2 inches. In an embodiment, the distance L_{T} is 1.02 inches.

In an embodiment, the distance H_{S} from the top surface 2202 to the bottom edge of each lateral surface 2302a, 2302b is 1 inch. In an embodiment, the distance L_{O} from the rear edge of each lateral surface 2302a, 2302b to each opening 2304a, 2304b is 0.32 inches.

In an embodiment, the perpendicular distance H_{T} from the top surface 2202 to the edge of the tang 2204 is 0.19 inches. In an embodiment, the distance Hₒ from the top surface 2202 to the center of each opening 2304a, 2304b in the lateral surfaces 2302a, 2302b is 0.68 inches.

As shown in FIG. 26, the housing bracket 2200 may be attached to a log splitter assembly 100. The housing bracket 2200 may be configured to secure a bearing 2502 to the housing bracket 2200 such that the bearing 2502 is configured to roll along the log support surface 112a of the structural assembly 112. The housing bracket 2200 may provide support for the rack 204 and/or the ram head 108.

In use, debris such as dirt and chunks of wood may enter the housing bracket 2200. If the bearing 2502 and/or the housing bracket 2200 become clogged with debris, the bearing 2502 may be obstructed from rolling freely, and the ram head 108 may be slowed or completely prevented from rolling out, thereby preventing the log splitter assembly 100 from functioning.

The design of the housing bracket 2200 prevents debris from accumulating within the housing bracket 2200 through the use of the notch 2206. This notch 2206 allows debris to exit the housing bracket 2200, permitting the bearing 2502 to rotate freely. As shown, the bearing 2502 sits directly beneath the notch 2206, such that any debris that accumulates on the bearing 2502 will be expelled through the notch 2206 as the bearing rotates.

The shape and placement of the tang 2204 prevents the bearing 2502 and/or the housing bracket 2200 from rotating on the vertical axis. In this manner, the bearing 2502 is kept in alignment, ensuring proper operation of the log splitter assembly 100.

One of skill in the art will recognize that all the various components identified in this disclosure may be made from any material or combination of materials suitable for the expected structural load and environment for the log splitter assembly including, without limitation, metals, composites, engineered plastics, natural or synthetic materials, or the like, etc. Furthermore, such components may be formed in any conventional manner, such as by molding, casting, machining, cold or hot forming, forging or the like, etc. Still further, such components may be finished in any conventional manner, such as painting, powder coating, plating or the like, etc., or they may be unfinished. Similarly, one of skill in the art will recognize that all measurements indicated herein are examples, and other sizes or measurements may be used.

Furthermore, while the particular preferred embodiments have been shown and described, it is obvious to those skilled in the art that changes and modifications may be made without departing from the teaching of the disclosure. The matter set forth in the foregoing description and accompanying drawings is offered by way of illustration only and not as limitation. The actual scope of the disclosure is intended to be defined in the following claims when viewed in their proper perspective based on the related art.

What is claimed is:

1. A log splitter assembly, comprising:
a frame assembly comprising a vertical receiving bracket with a front face with a first plurality of vertically spaced holes arranged thereon opposing a rear face with a second plurality of vertically spaced holes arranged thereon, wherein the front face is separated from the rear face by a first width;
a leg assembly with a top end comprising a leg bracket with a forward surface with a third plurality of vertically spaced holes arranged thereon opposing a rearward surface with a fourth plurality of vertically spaced holes arranged thereon and a bottom end comprising an axle extending substantially horizontally from a lateral surface which separates the forward surface from the rearward surface, wherein the forward surface is separated from the rearward surface by a second width that is less than the first width;
a wheel rotatably connected to the axle; and
a fastener configured to be removably inserted into first respective ones of the first plurality of vertically spaced holes, the second plurality of vertically spaced holes, the third plurality of vertically spaced holes, and the fourth plurality of vertically spaced holes so as to secure the vertical receiving bracket to the leg assembly with a first distance between the frame assembly and the wheel and second respective ones of the first plurality of vertically spaced holes, the second plurality of vertically spaced holes, the third plurality of vertically spaced holes, and the fourth plurality of vertically spaced holes so as to secure the vertical receiving bracket to the leg assembly with a second distance between the frame assembly and the wheel;
wherein the first distance is less than the second distance.

2. The log splitter of claim 1, wherein the frame assembly further comprises a side face with a first flange connected to the front face spaced apart from a second flange connected to the rear face, wherein the side face is configured such that the axle extends between the first flange and the second flange when the fastener is removably inserted into the first respective ones of the first plurality of vertically spaced holes, the second plurality of vertically spaced holes, the third plurality of vertically spaced holes, and the fourth plurality of vertically spaced holes.

3. The log splitter of claim 1, wherein the log splitter further comprises:
a structural assembly connected to the frame assembly;
a splitting wedge connected to a log support surface of the structural assembly;
a ram operatively connected to a rack, wherein the ram is supported by a ram head slider which is configured to movably rest on the structural assembly;
a source of rotational energy, wherein the rack is configured to move into operative engagement with the source of rotational energy to move the ram head slider along the log support surface towards the splitting wedge.

4. The log splitter assembly of claim 3, wherein:
the log splitter further comprises a tow bar movably connected to said structural assembly via a horizontal receiving bracket;
said log splitter assembly is configured such that an extension distance between the front end of said tow bar and the front end of said structural assembly may be adjusted; and
said horizontal receiving bracket comprises a bottom surface separated from a top surface such that said tow bar may be movably inserted between said top surface and said bottom surface.

5. The log splitter assembly of claim 4, wherein the horizontal receiving bracket further comprises:
a pair of lateral surfaces separated by an interior width, each of the lateral surfaces stretching between the top surface and the bottom surface, wherein each of the lateral surfaces includes a hole formed thereon for receiving a fastener;
wherein the tow bar comprises a first vertical surface and a second vertical surface with a plurality of lateral openings running therebetween for receiving the fastener;
wherein an exterior width measured between the exterior of the first vertical surface and the second vertical surface is less than the interior width;
wherein the plurality of lateral openings are arranged such that the tow bar may be secured in both an extended position wherein the extension distance is a first extension distance and a retracted position wherein the extension distance is a second extension distance; and
wherein the first extension distance is greater than the second extension distance.

6. The log splitter assembly of claim 5, wherein the tow bar further comprises:
a first end and a second end located opposite thereof;
wherein a tow hitch is secured to the first end and the second end includes a protrusion that extends a protruding distance from the first vertical surface; and
wherein the combination of the exterior distance and the protruding distance is greater than the interior distance.

7. The log splitter assembly of claim 6, wherein the protrusion is a first protrusion, the protruding distance is a first protruding distance and the tow bar further comprises a second protrusion that extends a second protruding distance from the second vertical surface and wherein the combination of the exterior distance, the first protruding distance, and the second protruding distance is greater than the interior distance.

8. The log splitter assembly of claim 7, wherein the first protrusion is a first end of a security fastener, the second protrusion is the second end of a security fastener, the tow bar includes a first security opening in the first vertical surface and a second security opening in the second vertical surface, and the security fastener is removably secured such that the first end protrudes from the first security opening and the second end protrudes from the second security opening.

9. The log splitter assembly of claim 3, wherein leg assembly is a right leg assembly, the vertical receiving bracket is a right vertical receiving bracket, the wheel is a right wheel and the log splitter assembly further comprises:
a left leg receiving bracket, a left leg assembly and a left wheel which are configured substantially equivalently to the right leg receiving bracket, the left leg assembly and the left wheel.

10. The log splitter assembly of claim 9, wherein the log splitter assembly further comprises:
a tow bar movably connected to said structural assembly;
a front leg receiving bracket secured to the tow bar, wherein the front leg receiving bracket comprises a pair of spaced-apart surfaces, each with a plurality of vertically spaced openings arranged thereon and aligned to form pairs of spaced-apart openings;
a front leg assembly with a plurality of horizontally extending apertures formed thereon rotatably connected to a front wheel;
a front fastener inserted through one of the pairs of spaced apart openings and one of the horizontally extending apertures and removably secured in place.

11. The log splitter assembly of claim 3, wherein the log splitter assembly further comprises:
a pinion gear shaft operatively connected to the source of rotational energy;
a rack support spring connected to the rack and configured to hold the rack above the pinion gear shaft;
a spindle assembly located above and in contact with the rack, wherein rotating the spindle assembly presses the rack into the pinon gear shaft; and
an engagement rod operatively connecting an engagement handle to the spindle assembly, wherein the lifting the engagement rod causes the spindle assembly to rotate and wherein rotating the engagement handle in an upward direction lifts the engagement rod.

12. The log splitter assembly of claim 11, wherein the log splitter assembly further comprises:
a lock out pin located above and in contact with the spindle assembly and operatively connected to a safety handle and to a spring return, wherein the lock out pin prevents the spindle assembly from rotating while the lock out pin is in place and the spring return holds the lock out pin in contact with the spindle assembly; and
wherein rotating the safety handle forward contracts the spring return and moves the lock out pin away from the spindle assembly such that the spindle assembly may rotate.

13. The log splitter assembly of claim 3, wherein the safety handle and the engagement handle comprise a shock absorbent material and the log splitter assembly further comprises a shock-absorbent coating on respective portions of the surface of the safety handle and the engagement handle.

14. The log splitter assembly of claim 3, wherein the log splitter assembly further comprises:
an adjustment bracket comprising a spring mount flange with a plurality of spaced-apart adjustment openings longitudinally spaced thereon, wherein the adjustment bracket is connected to the frame assembly;
a retraction spring operatively connected to the ram head slider and the adjustment bracket via a first one of the plurality of spaced-apart adjustment openings, wherein the retraction spring is configured to pull the ram head slider away from the splitting wedge;
wherein the tension in the retraction spring may be increased by disconnecting the adjustment spring from the first one of the plurality of spaced-apart adjustment openings and operatively connecting the retraction spring to a second one of the plurality of spaced-apart adjustment openings, wherein the second one of the plurality of spaced-apart adjustment openings is located farther from the ram head slider than the first one of the plurality of spaced-apart adjustment openings.

15. The log splitter assembly of claim 3, wherein the log splitter assembly further comprises:
a housing bracket attached to the ram head slider, wherein the housing bracket is hollow and comprises a top surface with a tang and a notch thereon and the tang protrudes in an upward direction such that a portion of the tang is perpendicular to the top surface; and
a bearing rotatably attached to the housing bracket and configured to rest inside the hollow portion of the housing bracket, wherein the notch is located substantially above the bearing.
